(19) United States
(12) Patent Application Publication
(10) Pub. No.: US 2015/0177600 A1
(43) Pub. Date: Jun. 25, 2015

(54) Projection Display Apparatus

(71) Applicant: Masateru Matsubara, Tokyo (JP)

(72) Inventor: Masateru Matsubara, Tokyo (JP)

(73) Assignee: NEC Display Solutions, Ltd.

(21) Appl. No.: 14/405,713

(22) PCT Filed: Jun. 8, 2012
(86) PCT No.: PCT/JP2012/064740

§ 371 Date: Dec. 4, 2014

(51) Int. Cl. G03B 21/14; G03B 21/28

(52) U.S. Cl. CPC G03B 21/142; G03B 21/28

(57) ABSTRACT

In a projection display apparatus, laser beams that are emitted from light sources and that are reflected and two-dimensionally scanned by scanning mirrors are modulated by a light bulb, and are then magnified through a projection lens to be projected. The F numbers of the scanning mirrors are smaller than that of the projection lens. The irradiation regions of the laser beams that are reflected by the scanning mirrors with respect to the light bulb are reduced by a lens.

### TECHNICAL FIELD

The present invention relates to a scanning type projection display apparatus.

### BACKGROUND ART

There is a projection display apparatus capable of projecting a two-dimensional image or video to a projection surface by scanning a laser beam in every direction. Such a projection display apparatus can be reduced in size and price because its structure is generally simple.

Patent Literature 1 discloses a scanning type projection display apparatus. This scanning type projection display apparatus includes laser light sources of respective colors of red (R), green (G), and blue (B), a cross prism, a scanning mirror, a light bulb, and a projection lens. In the scanning type projection display apparatus, a laser beam that is emitted from the laser light source of each color and that is reflected by the cross prism is reflected by the scanning mirror to be a rectangular two-dimensional scanning light. The two-dimensional scanning light enters the light bulb to be modulated, and then is magnified through the projection lens to be projected as an image or a video. Thus, the scanning type projection display apparatus can project the image or the video to a projection surface.

### CITATION LIST

Patent Literature 1: JP2003-186112A

### SUMMARY OF INVENTION

### Problems to be Solved

The projection display apparatus can be carried more easily because it is more compact. The use of such a compact projection display apparatus enables projection of videos or imagers in a variety of places. Accordingly, further miniaturization of the projection display apparatus is desired.

It is therefore an object of the present invention to provide a compact scanning type projection display apparatus.

### Solution to Problem

According to the present invention, a projection display apparatus, in which laser beams that are emitted from light sources and that are reflected and two-dimensionally scanned by scanning mirrors are modulated by a light bulb, and are then magnified through a projection lens to be projected, is characterized in that the F numbers of the scanning mirrors are smaller than that of the projection lens and is characterized by including a lens for reducing the irradiation regions of the laser beams reflected by the scanning mirrors with respect to the light bulb.

### BRIEF DESCRIPTION OF DRAWINGS

FIG. 1 is a schematic diagram illustrating a configuration of a projection display apparatus according to the first exemplary embodiment of the present invention;

FIG. 2 is an explanatory diagram illustrating the beam diameter of a laser beam transmitted through a condensing lens;

FIG. 3 is an explanatory diagram illustrating scanning of the laser beam by a scanning lens;

FIG. 4 is an explanatory diagram illustrating an image drawn by the laser beam reflected by the scanning lens;

FIG. 5 is an explanatory diagram illustrating the position adjustment of a folding mirror;

FIG. 6 is a perspective view illustrating the projection display apparatus illustrated in FIG. 1; and

FIG. 7 is a schematic diagram illustrating a configuration of a projection display apparatus according to the second exemplary embodiment of the present invention.

### DESCRIPTION FO EMBODIMENTS

### First Exemplary Embodiment

First, the outline of the operation of a projection display apparatus according to the first exemplary embodiment of the present invention will be described.

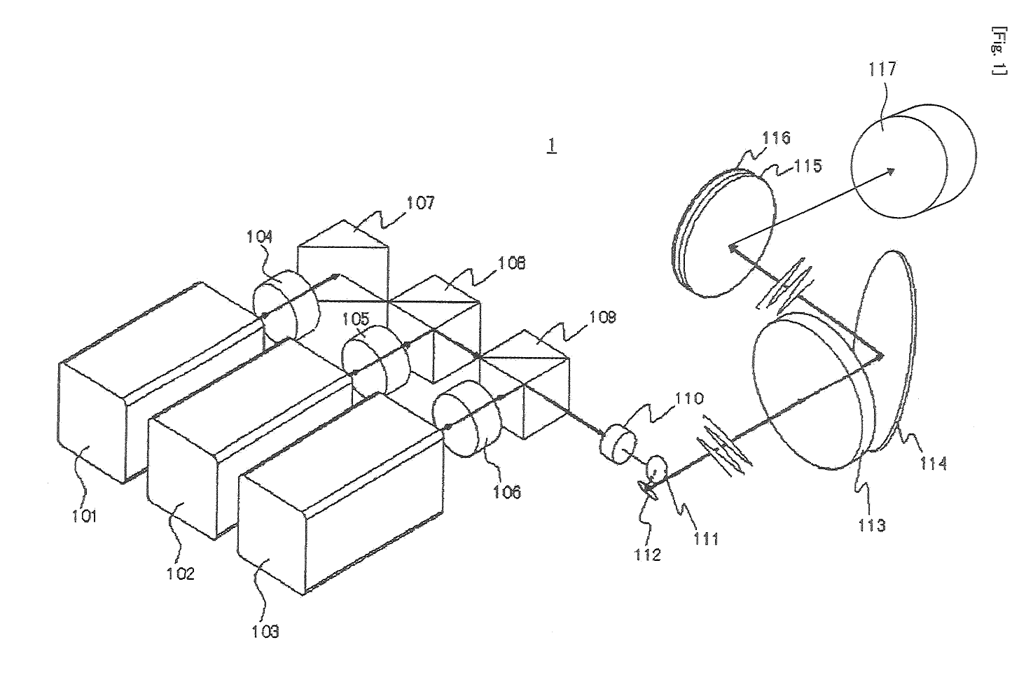

FIG. 1 is a schematic diagram illustrating a configuration of projection display apparatus 1 according to the exemplary embodiment. In projection display apparatus 1, first, laser beams that are emitted from laser light sources 101, 102, 103 enter condensing lens 110 through collimator lenses 104, 105, 106 and dichroic prisms 107, 108, 109. The laser beams that are transmitted through condensing lens 110 are sequentially reflected by vertical scanning mirror 111 and horizontal scanning mirror 112 to be rectangular two-dimensional scanning light, and enter collimator lens 113. The two-dimensional scanning light that are transmitted through collimator lens 113 is reflected by folding mirror 114 to enter through cover glass 115 into DMD (Digital Micromirror Device) 116 that is a light bulb configured as a collection of many mirrors. The two-dimensional scanning light that are modulated by DMD 116 based on an image signal or a video signal is magnified through projection lens 117 to be projected to a projection surface.

Next, each unit of projection display apparatus 1 according to the exemplary embodiment will be described in detail.

Laser light sources 101, 102 and 103 emit laser beams of three primary colors of red (R), green (G) and blue (B) by several watts. Specifically, laser light source 101 emits a laser beam having a red wavelength (about 640 nm), laser light source 102 emits a laser beam having a green wavelength (about 530 nm), and laser light source 103 emits a laser beam having a blue wavelength (about 440 nm). Laser light sources 101, 102 and 103 are arranged so that the laser beams that are emitted therefrom can advance side by side. The cross-section of a light flux that is emitted from each of laser light sources 101, 102 and 103 is a circle or an ellipse having a predetermined diameter.

Laser light sources 101, 102 and 103 subject the laser beams to pulse oscillation. Laser light sources 101, 102 and 103 are repeatedly switched ON and OFF at different timings. This eliminates the necessity of providing a member such as a color wheel for changing white light to each color light, and thus projection display apparatus 1 according to the exemplary embodiment can be miniaturized.

Collimator lenses 104, 105 and 106 adjust the laser beams that are emitted from laser light sources 101, 102 and 103 to be parallel light and set them to desired beam diameters. When laser light sources 101, 102 and 103 emit laser beams which include light fluxes having the noncircular cross-sections, such as semiconductor lasers, collimator lenses 104, 105 and 106 also serve to change the cross-sections of the light fluxes of the laser beams into circular form.

Dichroic prisms 108, 109 and 110 are members that respectively reflect the red, green, and blue laser beams and transmit beams of other colors. Specifically, the red laser beam that is transmitted through collimator lens 104 is reflected by dichroic prism 107, and is transmitted through dichroic prisms 108 and 109 to enter condensing lens 110. The green laser beam that is transmitted through collimator lens 105 is reflected by dichroic prism 108, and transmitted through dichroic prism 109 to enter condensing lens 110. The blue laser beam that is transmitted through collimator lens 106 is reflected by dichroic prism 109 to enter condensing lens 110. In the exemplary embodiment, dichroic prism 107 only needs to have a function of reflecting the red laser beam. Thus, dichroic prism 107 can be substituted with a normal mirror.

Condensing lens 10 is a lens for adjusting the beam diameter of the laser beam that enter each lens of DMD 116. The laser beam that is transmitted through condensing lens 10 is a Gaussian beam. The beam diameter ω(X) of the laser beam that is transmitted through condensing lens 10 is represented by the following Formula.

$$ω ( X ) = {{ω}_{0} [ 1 + {( \frac{λ \cdot X}{π \cdot {ω}_{0}} )}^{2} ]}^{1 / 2} \qquad [ Formula 1 ]$$

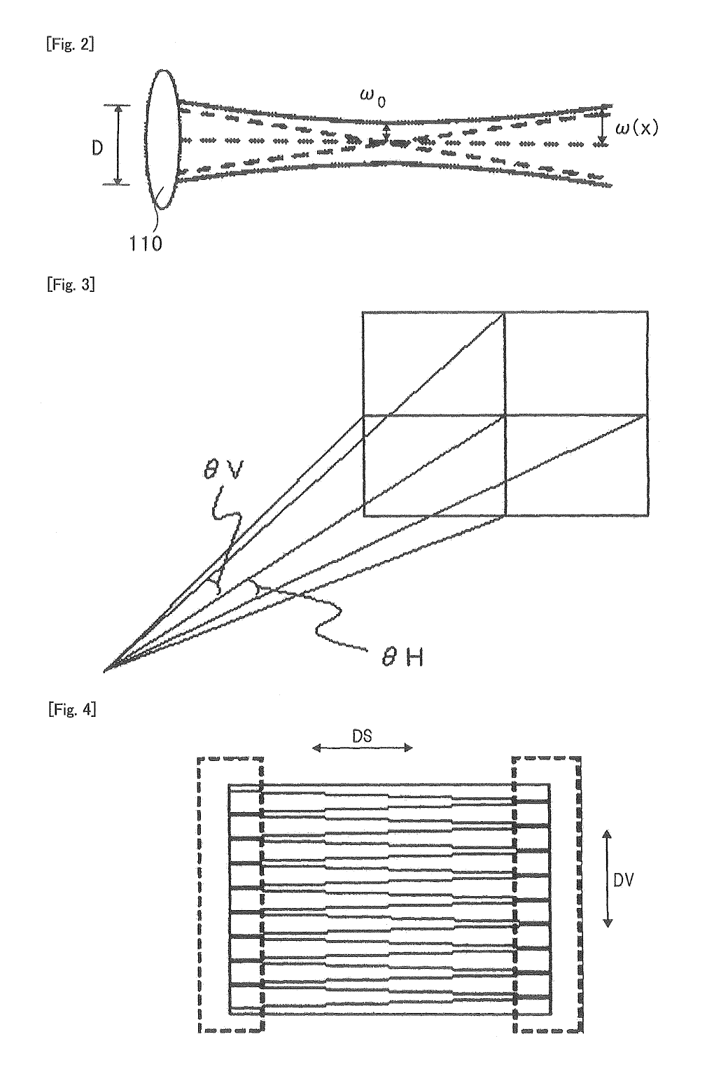

As illustrated in FIG. 2, ω₀ denotes a beam diameter at a beam waist, X denotes a distance from the beam waist, and λ denotes the wavelength of the laser beam. As is clear from the

Formula, the farther that beam diameter ω(X) is from the position of the beam waist, the larger the beam diameter. The position of the beam waist depends on the focal distance f of condensing lens 110. The beam diameter ω₀ at the beam waist is represented by the following Formula.

$$2 {ω}_{0} = \frac{4 λ \cdot f}{π \cdot D} \qquad [ Formula 2 ]$$

D denotes the initial diameter of the beam that is entered into condensing lens 110. Thus, the beam diameter ω₀ at the beam waist depends on the initial beam diameter D. The size of the initial beam diameter is determined by collimator lenses 104, 105 and 106.

Thus, the beam diameter of the laser beam that is entered into each mirror of DMD 116 can be determined by adjusting the focal distance of condensing lens 110 according to the initial beam diameter D.

Vertical scanning mirror 111 and horizontal scanning mirror 112 are formed by using a MEMS (Micro Electro Mechanical Systems) technology. Vertical scanning mirror 111 drives a reflection surface for reflecting the laser beam so that the reflected laser beam can be scanned back and forth with a predetermined frequency in a vertical direction. On the other hand, horizontal scanning mirror 112 drives a reflection surface for reflecting the laser beam so that the reflected laser beam can be scanned back and forth with a predetermined frequency in a horizontal direction. Thus, the laser beams that are sequentially reflected by vertical scanning mirror 111 and horizontal scanning mirror 112 are scanned back and forth in the vertical and horizontal directions orthogonal to each other to be two-dimensional scanning light.

As illustrated in FIG. 3, the scanning angle of vertical scanning mirror 111 is θV, and the scanning angle of horizontal scanning mirror 112 is θH. The laser beam that is reflected by vertical scanning mirror 111 is scanned back and forth at the scanning angle θV in the vertical direction, and enters horizontal scanning mirror 112 while drawing a sine curve in the vertical direction. The laser beam that is reflected by horizontal scanning mirror 112 is scanned back and forth at the scanning angle θH in the horizontal direction, and enters collimator lens 113 while drawing sine curves not only in the vertical direction but also in the horizontal direction.

Horizontal scanning mirror 112 is driven at a high frequency by vertical scanning mirror 111. In the exemplary embodiment, the driving frequency of vertical scanning mirror 111 is 60 Hz, and the driving frequency of horizontal scanning mirror 112 is several kHz to ten or so kHz.

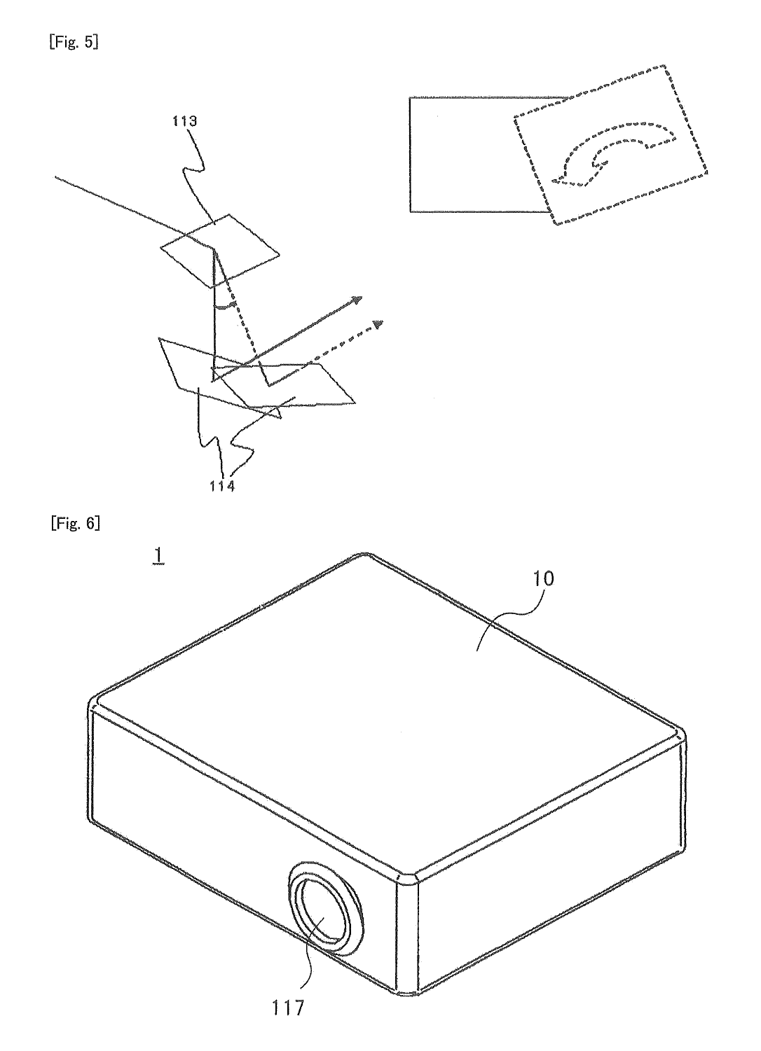

FIG. 4 illustrates the image of a laser beam that enters collimator lens 113 at the ¼ cycle of vertical scanning mirror 111. In FIG. 4, the vertical direction is indicated by arrow DV, and the horizontal direction is indicated by arrow DH. As illustrated in FIG. 4, the two-dimensional scanning light that enters collimator lens 113 is scanned by a plurality of cycles in horizontal direction DH during the ¼ cycle scanning in the vertical direction DV.

As described above, since the laser beams that are reflected by scanning mirrors 111 and 112 draw the sine curves in vertical direction VD and horizontal direction VH, the scanning speed of the laser beam is low at both ends in vertical direction VD and horizontal direction VH. Thus, in the two-dimensional scanning light that is reflected by scanning mirrors 111 and 112, illuminances at both ends in vertical direction VD and horizontal direction VH are high. In vertical direction DV, an illuminance difference between both ends of vertical direction DV and other parts is difficult to appear because of the low scanning speed of the laser beam. However, in horizontal direction DH, an illuminance difference between both ends of the vertical direction DV and other parts conspicuously appears because of the high scanning speed of the laser beam.

A region surrounded with a broken line in FIG. 4 is referred to as a blanking region. The blanking region is a region that has a high illuminance and that is generated due to the low scanning speed of the laser beam in horizontal direction DH.

To prevent the generation of a blanking region in the image of the two-dimensional scanning light, entry of any laser beam into the blanking region may be prevented. This can be achieved by cutting off the laser beam that enters the region surrounded with the broken line or by preventing laser light sources 101, 102 and 103 from generating any laser beams to enter the blanking region.

The generation of a portion of a high illuminance may be prevented by reducing the illuminance of the blanking region in the image of the two-dimensional scanning light. This can be achieved by weakening the output of a laser beam that enters the blanking region through a filter or the like, or by weakening the output of, among the laser beams that are emitted from laser light sources 101, 102 and 103, only the laser beam that enters the blanking region.

By these methods, the generation of a region of a high illuminance in the image of the laser beam can be prevented, in other words, the rectangular light flux of laser beams having a uniform illuminance distribution can be acquired. As a result, in the scanning type projection display apparatus according to the exemplary embodiment, there is no need to provide any member such as a light tunnel (rod integrator) to make the illuminance distribution of light fluxes uniform. Thus, scanning type projection display apparatus 1 according to the exemplary embodiment can be miniaturized.

In the exemplary embodiment, as the scanning mirror for acquiring the two-dimensional scanning light, two one-dimensional scanning mirrors 111 and 112 are used. However, a single two-dimensional scanning mirror may be used for acquiring the two-dimensional scanning light.

Collimator lens 113 is a lens for adjusting the F numbers of scanning mirrors 111 and 112. Collimator lens 113 will be described in detail below.

The F numbers of scanning mirrors 111 and 112 are represented as follows when the scanning angles θV and θH illustrated in FIG. 3 are used:
Vertical scanning mirror 111: F number=½ sin (θV)
Horizontal scanning mirror 112: F number=½ sin (θH)

Assuming that collimator lens 113 is not provided, in this case, the F numbers of scanning mirrors 111 and 112 must be equal to or higher than that of projection lens 117. This is because, when the F numbers of scanning mirrors 111 and 112 are lower than the F number of projection lens 117, the spread of the two-dimensional scanning light from scanning mirrors 111 and 112 is large, and a part of the two-dimensional scanning light may not be transmitted through projection lens 117. A part of the two-dimensional scanning light may accordingly be lost.

The F number of projection lens 117 is generally about 2.0. When the F number of projection lens 117 is 2.0, and the F numbers of scanning mirrors 111 and 112 are similarly 2.0, the scanning angles θV and θH of scanning mirrors 111 and 112 are 14.5°. Therefore, when the F number of projection lens 117 is 2.0, the scanning angles θV and θH of scanning mirrors 111 and 112 must be lower than 14.5°.

On the other hand, as the optical path between scanning mirrors 111 and 112 and DMD 116 is shorter, scanning type projection display apparatus 1 is more easily miniaturized. This necessitates scanning angles θV and θH of scanning mirrors 111 and 112 to be higher. However, when collimator lens 113 is not provided as described above, setting the scanning angles θV and θH of scanning mirrors 111 and 112 to be higher than 14.5° may cause the F numbers of scanning mirrors 111 and 112 to be smaller than 2.0 that is the F number of projection lens 117.

Therefore, in the exemplary embodiment, collimator lens 113 is provided to set the scanning angle of the laser beam that enters DMD 116 to be lower than scanning angles θV and θH of scanning mirrors 111 and 112. In other words, collimator lens 113 sets the scanning angle of the laser beam that enters DMD 116 to be lower than the scanning angles θV and θH of scanning mirrors 111 and 112. This enables reduction of the irradiation range of the laser beams that are reflected by scanning mirrors 111 and 112 with respect to DMD 116.

As a result, even when scanning angles θV and θH of scanning mirrors 111 and 112 are higher than 14.5°, the F number of the optical unit of scanning mirrors Wand 112 and collimator lens 113 as a whole can be set equal to or larger than the F number 2.0 of projection lens 117. In other words, all the two-dimensional scanning light that is transmitted through collimator lens 113 and that is modulated by DMD 116 enters projection lens 117. Accordingly, scanning type projection display apparatus 1 can be miniaturized by shortening the optical path between scanning mirrors 111 and 112 and DMD 116 without any two-dimensional scanning light loss.

Lens 113 is only required to have a diameter so that projection lens 117 can capture the two-dimensional scanning light that is reflected by scanning mirrors 111 and 112. In the exemplary embodiment, the collimator lens is used for lens 113. However, any lens can be used for lens 113 as long as it can reduce the F number of scanning mirrors 111 and 112 and lens 113 as a whole. Any lens can be used for lens 113 as long as it can set the scanning angle of the laser beam that enters DMD 116 in at least one of the vertical direction and the horizontal direction to be lower than those of scanning mirrors 111 and 112.

Folding mirror 114 is provided to adjust the angle of the two-dimensional scanning light that enters DMD 116. Folding mirror 114 can change, for example, the irradiation region indicated by the broken line to the irradiation region indicated by the solid line according to the position of DMD 116.

Folding mirror 114 may be installed or not installed according to the optical path design in projection display apparatus 1. When folding mirror 114 is not installed, the laser beam that is transmitted through lens 113 directly enters from DMD cover 115 into DMD 116.

DMD 116 is an optical element for modulating the two-dimensional scanning light of the laser beam based on an image signal or a video signal. DMD 116 includes many mirrors arranged in a rectangular form, and the laser beam enters each mirror. The respective mirrors of DMD 116 individually switch the directions of their reflection surfaces to be set ON or OFF. In other words, each mirror causes the incident laser beam to enter projection lens 117 when ON, while it does not cause the incident laser beam to enter projection lens 117 when OFF. Accordingly, DMD 116 modulates the incident two-dimensional scanning light.

In the exemplary embodiment, the modulation of the two-dimensional scanning light is performed by DMD 116. However, the modulation of the two-dimensional scanning light can be performed by laser light sources 101, 102, and 103. In other words, the modulation of the two-dimensional scanning light can be similarly performed by changing the outputs of the laser beams from laser light sources 101, 102, and 103 according to the image signal or the video signal. In particular, for displaying a dark color image or video, modulation of two-dimensional scanning light by laser light sources 101, 102 and 103 is more suitable than that by DMD 116.

The modulation of the two-dimensional scanning light by DMD 116 and the modulation of the two-dimensional scanning light by laser light sources 101, 102 and 103 can be combined. Accordingly, an image or a video of higher contrast can be displayed.

Projection lens 117 magnifies the light that enters from DMD 116 to project it to the projection surface. For projection lens 117, those of F numbers 1.8 to 2.4 are generally used. Not limited to these, however, various projection lenses are used.

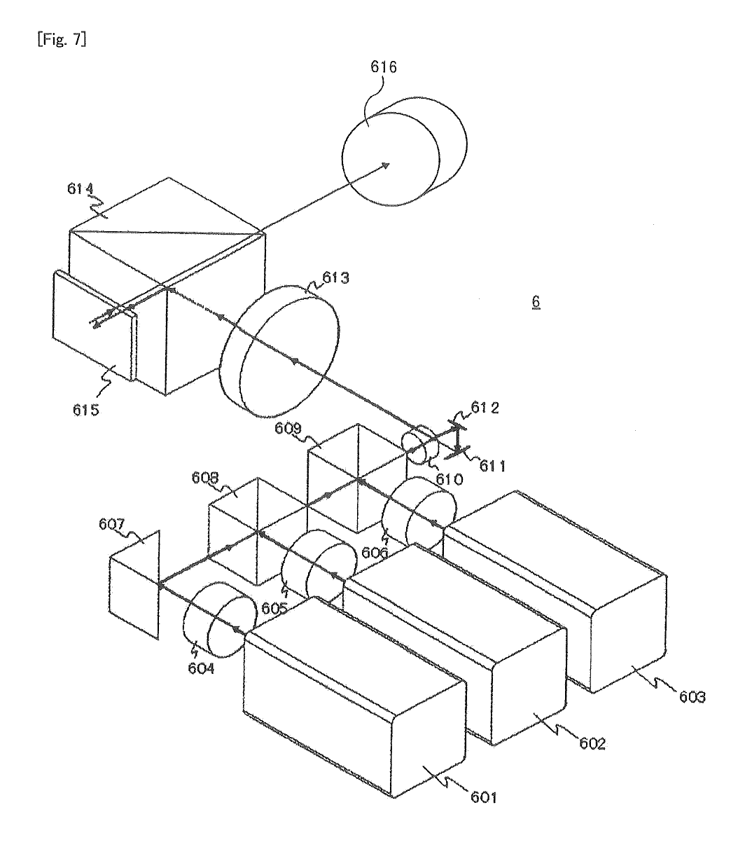

FIG. 6 is a perspective view illustrating projection display apparatus 1 according to the exemplary embodiment. Projection display apparatus 1 includes casing 10 for covering all the members illustrated in FIG. 1. Only projection lens 117 is exposed to a side face from casing 10. Changing of the projection direction of the image or the video by projection display apparatus 1 is performed by changing the direction of projection lens 117 along with casing 10.

In the scanning type projection display apparatus, due to the use of the laser beams, the laser beams that are projected from projection lens 117 may directly enter into human eyes. The entry of the laser beams into the human eyes may damage the eyes. However, in projection display apparatus 1 according to the exemplary embodiment, the laser beams that are emitted from laser light sources 101, 102 and 103 as laser beam generation sources reach projection lens 117 via various members, and the laser beams are widely diffused by projection lens 117. As a result, in projection display apparatus 1 according to the exemplary embodiment, the laser beams that are projected from projection lens 117 are weakened, and damage caused to the eyes by the laser beams projected from projection lens 117 is prevented.

### Second Exemplary Embodiment

First, the outline of the operation of a projection display apparatus according to the second exemplary embodiment of the present invention will be described.

FIG. 7 is a schematic diagram illustrating a configuration of projection display apparatus 6 according to the exemplary embodiment. In projection display apparatus 6, first, laser beams, which are emitted from laser light sources 601, 602 and 603, enter condensing lens 610 through collimator lenses 604, 605 and 606 and dichroic prisms 607, 608 and 609. The laser beams that are transmitted through condensing lens 610 are sequentially reflected by vertical scanning mirror 611 and horizontal scanning mirror 612 to be rectangular two-dimensional scanning light, and enter lens 613. The two-dimensional scanning light that is transmitted through collimator lens 613 is reflected by polarization beam splitter 614 to enter reflective liquid crystal display panel 615 that is a light bulb. The two-dimensional scanning light that is modulated by reflective liquid crystal display panel 615 based on an image signal or a video signal is transmitted through polarization beam splitter 614 and magnified through projection lens 616 to be projected to a projection surface.

Next, each unit of projection display apparatus 6 according to the exemplary embodiment will be described in detail.

The projection display apparatus according to this exemplary embodiment is different from the projection display apparatus of the first exemplary embodiment in that not the DMD but reflective liquid crystal display panel 615 is used for the light bulb. Other components are similar to those of the projection display apparatus of the first exemplary embodiment.

In the exemplary embodiment, polarization beam splitter 614 is provided between lens 613 and reflective liquid crystal display panel 615. Polarization beam splitter 614 has a function of reflecting a laser beam (S-polarized light) that is transmitted through lens 613 toward reflective liquid crystal display panel 615 and of transmitting a laser beam (P-polarized light) modulated by reflective liquid crystal display panel 615 to cause it to enter projection lens 616.

Reflective liquid crystal display panel 615 is an optical element for modulating two-dimensional scanning light based on the image signal or the video signal. Reflective liquid crystal display panel 615 includes a liquid crystal layer. Each portion of the liquid crystal layer of reflective liquid crystal display panel 615 can change the output of the laser beam of the P-polarized light that is emitted to projection lens 616 according to the increase/decrease of electric field application. Accordingly, reflective liquid crystal display panel 615 modulates the incident two-dimensional scanning light.

The modulation of the two-dimensional scanning light can be performed not only by reflective liquid crystal display panel 615 but also by a combination of laser light sources 601, 602 and 603 and polarization beam splitter 614.

Projection lens 616 magnifies the light incident from reflective liquid crystal display panel 615 through polarization beam splitter 614 to project it to the projection surface.

The exemplary embodiments of the present invention have been described. However, the present invention is not limited to the exemplary embodiments. Various changes understandable to those skilled in the art can be made to the configuration of the present invention without departing from the scope of the invention.

### REFERENCE NUMERALS

101, 102, 103 Laser light source
104, 105, 106 Collimator lens
107, 108, 109 Dichroic prism
110 Condensing lens
111 Vertical scanning mirror
112 Horizontal scanning mirror
113 Mirror
114 Folding mirror
115 DMD cover
116 DMD
117 Projection lens

1. A projection display apparatus, comprising:
light sources that emit laser beams;
scanning mirrors configured to reflect and two-dimensionally scan the laser beams from the light sources;
a light bulb configured to modulate the laser beams from the scanning mirrors; and
a projection lens that magnifies and projects the laser beams from the light bulb;
wherein F numbers of the scanning mirrors are smaller than that of the projection lens, and the projection display apparatus further comprises a lens configured to reduce irradiation regions of the laser beams that are reflected by the scanning mirrors with respect to the light bulb.

2. The projection display apparatus according to claim 1, wherein the lens comprises a collimator lens.

3. The projection display apparatus according to claim 1, wherein the scanning mirror includes two one-dimensional scanning mirrors driven in different directions.

4. The projection display apparatus according to claim 1, wherein the light sources comprise three types of light sources consisting of red, green, and blue.
